(19) United States
(12) Patent Application Publication
(10) Pub. No.: US 2006/0168320 A1
(43) Pub. Date: Jul. 27, 2006

(54) Network topology discovery service

(76) Inventors: Nelson F. Kidd, Camas, WA (US); Bryan Y. Roe, Camas, WA (US); Ylian Saint-Hilaire, Hillsboro, OR (US); James W. Edwards, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,744

(22) Filed: Dec. 30, 2004

(51) Int. Cl. G06F 15/173

(52) U.S. Cl. 709/238

(57) ABSTRACT

A method and apparatus for network topology discovery. An embodiment of a method includes receiving a request from a controller at a first network device, with the request inquiring whether a network path exists with a second network device; determining whether a network path between the first network device and the second network device exists; and sending a response to the controller.

### FIELD

An embodiment of the invention relates to computer networks in general, and more specifically to a network topology discovery service.

### BACKGROUND

In computer operations, multiple network devices, such as UPnP™ (Universal Plug and Play—UPnP Implementers Corp.) devices, may operate in a system, with the system possibly including multiple networks. In such a system, a group of two or more devices may or may not share any network connection, depending on the particular network topology.,

In a computer network, a control point may discover and desire to interact with multiple network devices. The operation of the control point may require that the network devices operate in a peer-to-peer manner and thus share a network path. For this reason, the control point may wish to determine whether a shared network path for the discovered network devices exists.

However, in a conventional operation a control point does not generally have a means for determining whether network devices are peers. A control point generally is only able to infer that certain network devices are peers if the network devices are discovered on the same network interface. If the devices are discovered on different network interfaces, the control point does not have knowledge regarding any network paths between the devices. In a conventional operation, a definitive determination of network peer status isn't available.

### BRIEF DESCRIPTION OF THE DRAWINGS

The invention may be best understood by referring to the following description and accompanying drawings that are used to illustrate embodiments of the invention. In the drawings:

FIG. 1 is an illustration of an embodiment of network topology discovery;

FIG. 2 illustrates an embodiment of network topology service processes for UPnP devices;

FIG. 3 is an illustration of an embodiment of an enterprise including a network topology system;

FIG. 4 illustrates an embodiment of bridging network endpoints that are determined to lack a network path;

FIG. 5 is a flow chart to illustrate various embodiments of processes for network topology discovery by a device; and

FIG. 6 is a block diagram of an embodiment of a UPnP device.

### DETAILED DESCRIPTION

A method and apparatus are described for network topology discovery.

In one embodiment of the invention, a controller may determine if a first device or element is a peer to a second device or element, even if the devices are on different network interfaces. In one embodiment, a controller may invoke an action on a first device to inquire whether the first device shares a network path with a second device, the first device returning a response to the controller.

In one embodiment of the invention, a first device receiving an inquiry from a controller makes a determination whether the first device shares a network path with a second device. In one embodiment, a device monitors a network to determine what other devices share network paths with the device. In one embodiment, a first device maintains variables or a map of network topology containing information regarding other devices with which the device shares network paths.

In one embodiment of the invention, a controller discovers multiple devices and determines that the devices do not share a network path. The controller utilizes virtualized representations of the devices to bridge the devices.

In one embodiment of the invention, a controller is a UPnP control point. The control point may discover one or more UPnP devices. In one embodiment of the invention, one or more of the devices contains a network topology service (which may be referred to herein as NTS) to allow discovery of network relationships. In one embodiment of the invention, a method and apparatus are provided to allow a UPnP device to determine if the device shares the same network with another UPnP device.

A UPnP control point may want to interact with two UPnP devices, with a requirement that the devices interact with each other in a peer-to-peer fashion. For example, a control point discovers two UPnP devices, with each device being located on a different network interface. At this point, the control point initially knows that the two UPnP devices were discovered on separate network cards, but does not know if the two UPnP devices have a network path between them. In one embodiment of the invention, a service that may be referred to as a UPnP network topology service (NTS) provides means to enable control points to understand the network topology of UPnP devices. UPnP devices that utilize the service enable control points to gather information regarding the network topology.

Universal plug-and-play (UPnP) is a set of computer network protocols that are promulgated by the UPnP Forum. (See Basic: 1.0, Device Definition Version 1.0 For UPnP Version 1.0, Feb. 12, 2002, and definitions for specific types of UPnP devices). UPnP is intended to enable devices to connect seamlessly and to simplify the implementation of networks. UPnP enables data communication between any two devices under the command of any control device on the network. A UPnP device may be regarded as a container of services, with a UPnP service being a unit of control in an UPnP network. A UPnP device may also include nested devices. A UPnP control point is a controller that is capable of discovering and controlling other UPnP devices.

In operation, when a device is added to a network, the UPnP discovery protocol allows that device to advertise its services to control points on the network. When a control point is added to a network, the UPnP discovery protocol allows the control point to search for devices of interest on the network. In such operations a discovery message is exchanged containing certain information regarding the device or its services. The UPnP discovery protocol is based on the simple service discovery protocol (SSDP), which defines discovery of network services on a network. SSDP defines methods for a control point to locate services on a network and for devices to announce their availability on the network.

Upon discovering a UPnP device, a control point may, among other proceses, retreive the device description and obtain a list of associated services for the device and invoke actions to control a service. Further, a control point may subscribe to a service's event source, the event service sending an event to the control point whenever the state of the service changes. After the control point has retrieved a description of a device, the control point may send actions to a service of the device. To accomplish this, the control point sends control message to the control URL for the service, as provided in the device description. Control messages are generally expressed in XML (extensible mark-up language) using the simple object access protocol (SOAP) of the World Wide Web Consortium (W3C). (For example, SOAP Version 1.2 recommendation, Jun. 24, 2003) In response to the control message, the service may returns a action-specific value. In one embodiment, the services of a device include a service for discovery of network topology.

In one embodiment of the invention, a service includes a IsPeerIP( ) action that instructs a UPnP device to detect if a network path exists to a specified IP address. The return value is a Boolean value indicating if a path exists.

In one embodiment of the invention, a service includes a IsPeerUDN( ) action that instructs a UPnP device to send an M-SEARCH request and determine whether a specific UPnP device's unique device name (UDN) is found. When a device is attached to a UPnP network, it may issue an M-SEARCH command to find other devices connected to the network. A device that receives a M-SEARCH command passes a NOTIFY directive back to announce their availability. In one embodiment, a return value for the IsPeerUDN( ) action is a Boolean value indicating whether the device received a response from the desired device.

In one embodiment of the invention, a service includes a PeerIPs state variable for a device, the state variable listing the known IP addresses that are peers to the device. In one embodiment, if a first UPnP device receives an action containing the IP address of a second UPnP device, the first UPnP device searches the PeerIPs state variable to determine whether the second UPnP device is included as a peer. In one embodiment of the invention, a service includes a PeerUDNs state variable for a device, the state variable listing the known UDNs that are peers to the device. In one embodiment, if a first UPnP device receives an action containing the UDN of a second UPnP device, the first UPnP device searches the PeerUDNs state variable to determine whether the second UPnP device is included as a peer.

In another embodiment of the invention, a first UPnP device actively monitors the UPnP network or networks that are interfaced with the device. In one embodiment, the monitoring activity includes examining the simple service discovery protocol multicast channel for device advertisements.

In another embodiment of the invention, UPnP devices are enabled to communicate topology information to each other in a peer-to-peer manner, allowing the devices to assign identifiers to their UPnP networks. In one embodiment of the invention, each of a number of UPnP devices includes a UPnP control point that is designed to interface with the network topology service of other devices. In an embodiment of the invention, an action is defined for network assignment, which may be designated as AssignNetworkID( ). The input arguments to this action are the desired network identifier and the time that the invoking device has been on the UPnP network. In response to this action, a target device will check the specified time for the invoking device against the target device's own time or age. If the relevant target device is younger (has been attached to a network for a shorter time period) than the invoking device, the target device will use the assigned network identifier. If the target device is older than the invoking device, then the target device returns a different network identifier (that either it created or was assigned by a different peer), thereby effectively instructing the invoking device to change its network ID assignment.

In one embodiment of the invention, UPnP devices and UPnP control points may build and maintain network topology maps. In a system, UPnP devices and control points may infer information from network communications, such as source IP addresses for received SOAP actions, IP address information from SSDP traffic, or information obtained by promiscuously sniffing the IP network. Using such information, the devices may build more complete representations of network topologies. Under one embodiment, once IP addresses are discovered, the validity of each IP address are monitored continuously, thereby providing real-time information regarding the network topology.

Under an embodiment of the invention, a service can be applied along with logic for bridging network endpoints that do not have a network route. In one example, a UPnP control point with multiple network interfaces discovers two UPnP devices on separate networks, for example a device A on a first network and a device B on a second network. In this example, at least one of the devices implements a network topology system, such as device A implementing the network topology service and device B lacking such service. In this example, the control point utilizes device A's network topology service and determines that a route does not exist between Device A and Device B. Upon discovering this topology information, the control point may bridge the devices by creating a virtualized representation of each UPnP device on the other device's UPnP network, such that Device A has a route to Device B′ and Device B has a route to Device A′. Further, the bridging of non-routable UPnP endpoints can be accomplished at various network layers, such as the bridging the IP network layer instead of bridging the UPnP network layer.

In one possible example, an embodiment of the invention may include a network topology service for a UPnP-AV device. UPnP AV is built on top of UPnP and is intended to connect and control audio-visual devices. In this example, a UPnP control point may instructs a media rendering device to play a specific URI (uniform resource identifier) source, but the URI source has an IP address without a network path to the rendering device. In such example, the control point may use the NTS to determine that the path does not exist and then to establish the necessary bridge to allow the media device to play the source.

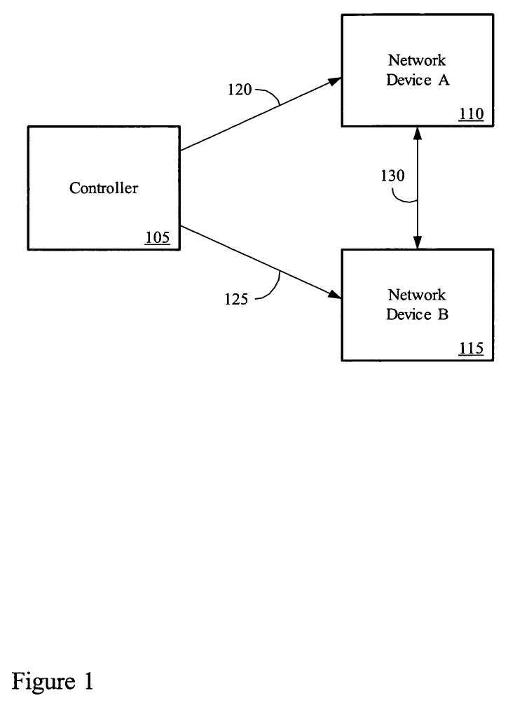

FIG. 1 is an illustration of an embodiment of network topology discovery. In this illustration, a controlling device 105 discovers two devices or elements, shown as a discovery 120 of a network device A 110 and a discovery 125 of a network device B 115. In one embodiment, controlling device 105 comprises a UPnP control point. In one embodiment, device A 110 and device B 115 comprise UPnP devices. In this illustration, the controlling device 105 requires that device A 110 and device B 115 communicate as peers. In one embodiment, the controlling device 105 makes an inquiry to either device A 110 or device B 115 regarding whether a connection 130 exists between device A 110 and device B 115. Under one embodiment, controlling device 105 provides an identification for one of the devices to the other device, with identification including, for example, an IP address or a UDN. In this embodiment, the receiving device returns a reply indicating whether the devices have a network path between them.

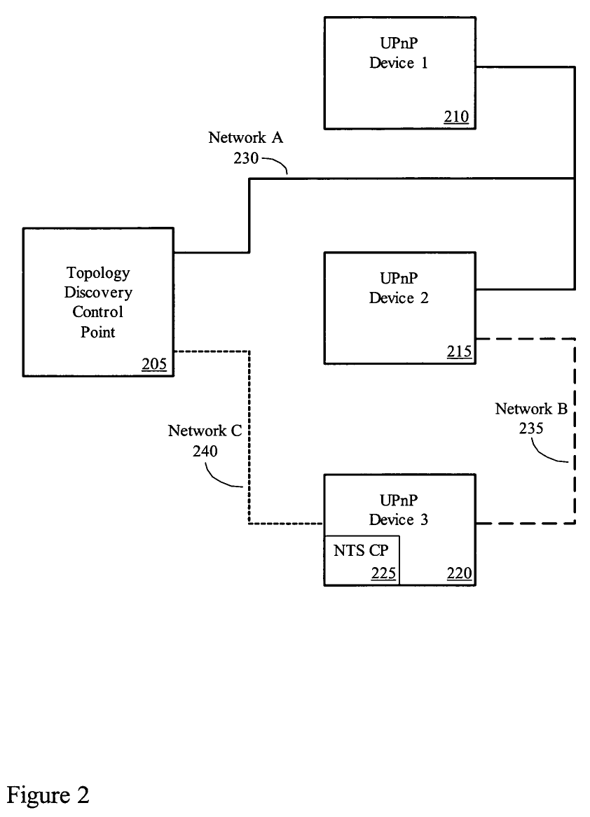

FIG. 2 illustrates an embodiment of network topology service processes for UPnP devices. In this example, a topology discover control point 205 may operate with one or more UPnP devices, which are illustrated as UPnP device 1 210, UPnP device 2 215, and UPnP device 3 220. In this illustration, one or more of the devices may include a network topology service control point, such as the control point 225 included with UPnP device 3 220. In this illustration the control point 205, UPnP device 1 210, and UPnP device 2 215 are connected by a first network, network A 230. UPnP device 2 215 and UPnP device 3 220 are connected by a second network, network B 235. The control point 205 and UPnP device 3 220 are connected by a third network, network C 240.

In FIG. 2, the control point 205 can see device 1 210 because the control point and device are both on network A 230, and the control point 205 can see device 2 215 because the devices are both on network A 230. In an embodiment of the invention, the control point 205 may obtain the IP address or UDN of device 2 215 and then invoke a network topology service action on device 1 210 to verify that device 1 210 is able to see device 2 215. In one embodiment, upon determining whether a network connection exists with device 2 215, device 1 210 returns a reply to control point 205. In various embodiments of the invention, device 1 210 may verify the existence of the connection with device 2 215 by varying means, including monitoring a multicast channel for SSDP advertisements coming from device 2 215; pinging the IP address of device 2 215; issuing a M-SEARCH command and monitoring the M-SEARCH responses for the UDN of device 2 215; and promiscuously sniffing network traffic for anything originating from the IP address of device 2 215.

In another example, the control point 205 can see device 2 215 because both are on network A 230, and the control point 205 can see device 3 220 because both are on network C 240. In an embodiment of the invention, if the control point 205 invokes a network topology service action on device 3 220 and provides the IP address of device 2 215, then device 3 220 will inform the control point 205 that it cannot see device 2 215 using a path on network A 230, the network used by the control point 205 to see device 2 215. However, if the control point invokes a network topology service action on device 3 220 and provides the UDN of device 2 215, then device 3 will inform the control point 205 that it can see device 2 215 on network B. In various embodiments of the invention, device 3 220 may verify the existence of the connection with device 2 215 by varying means. In another embodiment of the invention, device 3 220 includes the network topology service control point 225. The inclusion of control point 225 allows device 3 220, as a network entity, to detect the presence of device 2 215, as another network device. In this instance, device 3 220 may inform the control point 205 that a network path exists between device 2 215 and device 3 220 without requiring the control point 205 to provide the UDN of device 2 215.

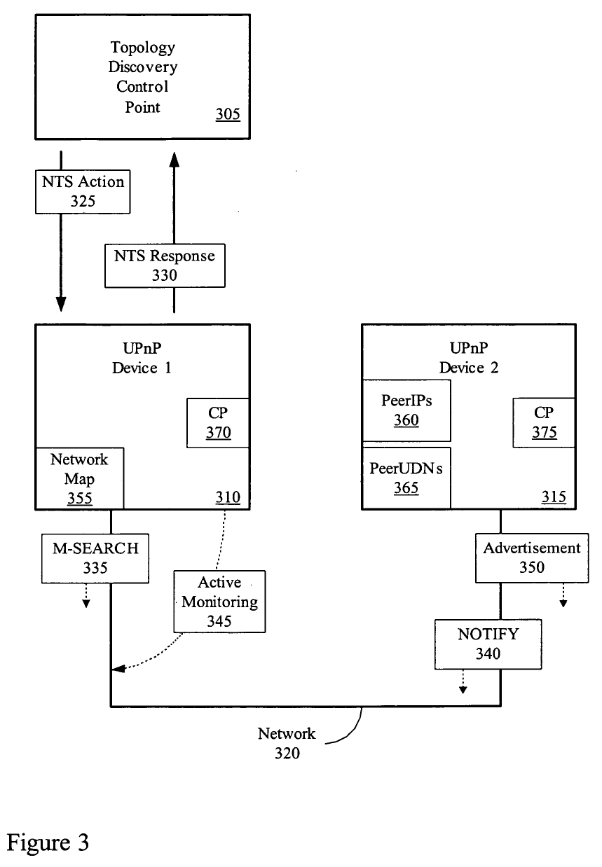

FIG. 3 is an illustration of an embodiment of an enterprise including a network topology system. In FIG. 3, a system utilizes a network topology service in the operation of UPnP devices. A topology discovery control point 305 may discover multiple UPnP devices, shown as UPnP device 1 310 and UPnP device 2 315. In an embodiment, the control point 305 uses the network topology service to determine whether there is a network connection between UPnP device 1 310 and UPnP device 2 315, such as the path of the illustrated network 320. In an embodiment, the control point sends a network topology service action to one of the discovered devices, such as the network topology service action 325 sent to UPnP device 1 310. The network topology service action 325 may contain identifying information regarding UPnP device 2 315, such as the IP address or UDN of UPnP device 2 315. The action 325 will inquire whether there is a network path between UPnP device 1 310 and UPnP device 2 315. After the UPnP device makes a determination whether a network path exists, a network topology service response 330 is sent from UPnP device 1 310 to the control point 305.

The manner in which a UPnP device determines whether a network path exists will vary according to the particular embodiment of the invention. In one embodiment, a UPnP device sends an M-SEARCH action 335 on the network. If the relevant device receives the M-SEARCH action 335, the device will return a NOTIFY response 340 to indicate that the device has received the action 335. In one embodiment a UPnP device actively monitors 345 a network 320. Monitoring may include monitoring for advertisements 350 that may be sent by the relevant device. In one embodiment, a device may include a network topology map, such as the network topology map 355 of UPnP device 1 310. In one embodiment, a device may include one or more state variables regarding network topology, such as PeerIPs state variable 360 to hold the IP addresses of known peers of UPnP device 2 315 and PeerUDNs state variable 365 to hold the UDNs of known peers of UPnP device 2 315. The network topology map and state variables of a device may be used to maintain data regarding any of any other devices that share network paths with the device. For example, the network topology map 355 of UPnP device 1 310 may contain data indicating whether a network path exists between UPnP device 1 310 and UPnP device 2 315. In an embodiment, UPnP device 1 310 maintains the network map 355 by monitoring any network connections for the device. In another embodiment, UPnP devices exchange data to develop and maintain data regarding network paths. In such embodiment, each device may include a control point, such as control point 370 of UPnP device 1 310 and control point 375 of UPnP device 2 315.

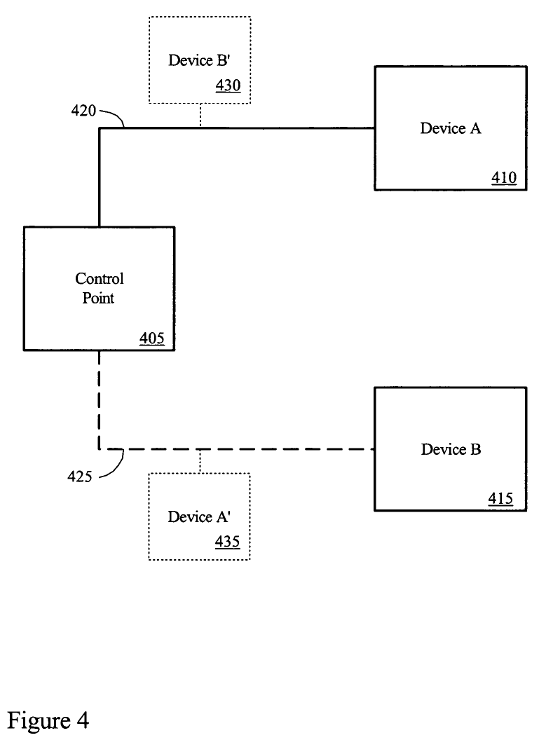

FIG. 4 illustrates an embodiment of bridging network endpoints that are determined to lack a network path. In one embodiment of the invention, a control point discovers two UPnP devices on separate networks, device A 410 on a first network 420 and device B 415 on a second network 425. In one embodiment, the control point utilizes a network topology service of either device A 410 or device B 415 to determine that a network path does not exist between device A 410 and device B 415. In one embodiment, the control point generates a virtualized representation of each UPnP device on the network of the other UPnP device to bridge the devices. For example, control point 405 generates a virtual device B′ 430 on the first network 420, thereby providing a route between device A 410 and virtual device B′ 430. Further, control point 405 generates a virtual device A′ 435 on the second network 425, thereby providing a route between device B 415 and virtual device A′ 435.

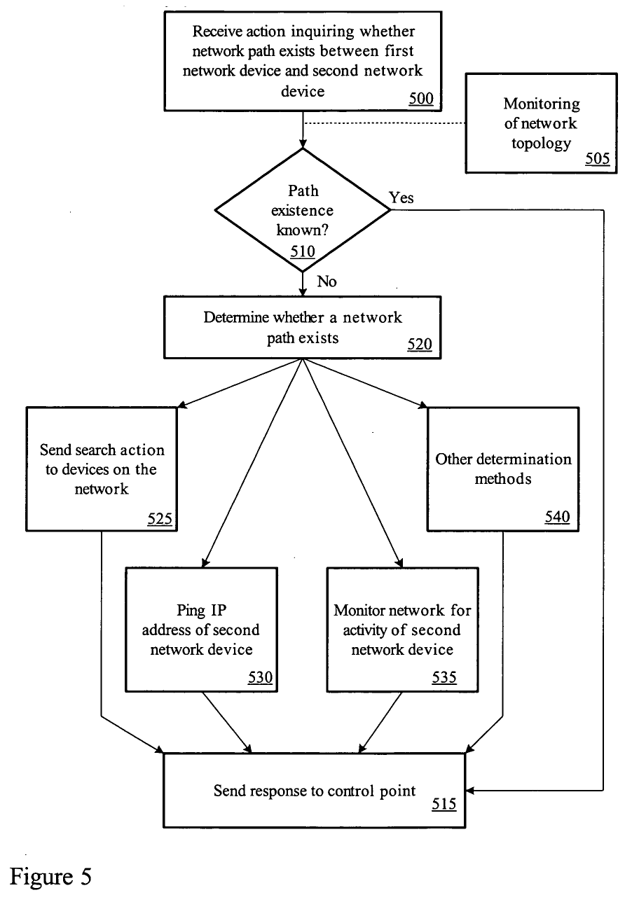

FIG. 5 is a flow chart to illustrate various embodiments of processes for network topology discovery by a device. In this illustration, a network topology service action from a control point is received by a first network device 500. The action identifies a second network device and inquires whether a network path exists between the first network device and the second network device. In one embodiment, the device may be monitoring the network topology 505 and thus may have information regarding the peer status of the second network device. If the first network device knows whether a network path exists 510, a response may be sent to the control point 515. For example, the first network device may know of the network path if the first network device maintains a network topology map. If the first network device does not know whether a network path exists, then the first network device determines whether a network path between the first network device and the second network device exists 520. In one embodiment, the determination is made by sending a search action to devices on the network and waiting for a response from the second network device 525. In another embodiment, the determination is made by pinging the IP address of the second network device 530. In another embodiment, the first network device monitors network activity to determine whether a network path exists 535. Other determination methods may also be utilized 540. After the determination whether the network path exist is made, a response is made to the control point 515.

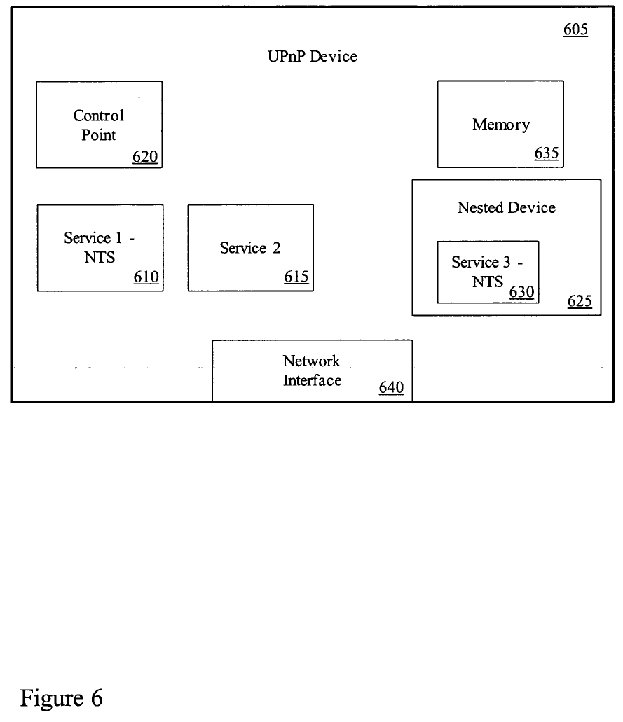

FIG. 6 is a block diagram of an embodiment of a UPnP device. FIG. 6 is a simplified general figure and does not contain all elements of a device, which may vary greatly. A UPnP device may be viewed as a container of services and nested devices. In this example, a UPnP device 605 may include multiple services, such as service 1 610 and service 2 615. In one embodiment of the invention, the services may include a network topology service (NTS), shown as service 1 610. The network topology service 610 enables the UPnP device to operate with a control point and other devices in determining the network topology. For example, the UPnP device 605 may receive an action from a control point inquiring whether the UPnP device 605 is a peer with another UPnP device. In one embodiment, the network topology service 610 may determine whether a network path exists or may be used to maintain network topology data. In one embodiment, the network topology service 610 may provide a response to a control point regarding the existence of a network path.

The UPnP device may also contain a control point 620. Under an embodiment of the invention, the control point 620 may be utilized in conjunction with the network topology service 610. Further, the UPnP device 605 may include one or more nested devices, such as nested device 625. In one embodiment, the nested device 625 may also include a network topology service 630. The UPnP device 605 may include a memory 635, with the memory possibly including network topology data. The UPnP device includes one or more network interfaces 640 to connect the device with a network, a network interface being used to communicate with a control point or another UPnP device.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
receiving a request from a controller at a network device, the request asking whether a network path exists between the network device and a second network device;
determining whether a network path with the second network device exists; and
sending a response to the controller, the response indicating whether the network path exists.

2. The method of claim 1, wherein the controller comprises a UPnP (universal plug and play) control point.

3. The method of claim 1, wherein determining whether the network path exists comprises sending a request to devices on a network asking for a response if the request is received.

4. The method of claim 3, wherein the request comprises an M-SEARCH action.

5. The method of claim 1, wherein determining whether the network path exists comprises monitoring a network to determine whether the second network device is connected to the network.

6. The method of claim 5, wherein monitoring the network comprises listening for SSDP (simple service discovery protocol) advertisements from the second network device.

7. The method of claim 1, further comprising exchanging network topology data with the second network device.

8. A method comprising:
discovering a first network device and a second network device;
sending a request to the first network device, the request asking whether the first network device shares a network path with the second network device; and
receiving a response to the request from the first network device.

9. The method of claim 8, wherein the first network device and the second network device comprise UPnP (universal plug and play) devices.

10. The method of claim 9, wherein the request includes the IP (Internet protocol) address of the second network device.

11. The method of claim 8, wherein the request includes the UDN (unique device name) of the second network device.

12. The method of claim 8, further comprising establishing a network connection if the response indicates that the network path does not exist.

13. A network device comprising:
a network interface to connect with a network, the network device to receive a request from a controller over the network interface, the request inquiring whether the network device has a network path to a second network device; and
a network topology service, the network topology service to determine whether the network device has a path to the second network device.

14. The network device of claim 13, wherein the network device is a universal plug and play (UPnP) device.

15. The network device of claim 13, further comprising a control point, the control point to discover network topology information for the network device.

16. The network device of claim 13, further comprising a memory, the memory containing network topology data.

17. The network device of claim 16, wherein the network topology data includes a network topology map.

18. The network device of claim 16, wherein the network topology data includes a state variable to contain information regarding peers of the network device.

19. A system comprising:
a network;
a plurality of universal plug and play (UPnP) devices connected to the network, the plurality of network devices including a first device and a second device, the first device comprising a network topology service; and
a UPnP control point connected to the network, the control point to discover the first device and the second device, the control point to generate an action to the network topology service of the first network device to inquire whether the second device is a peer of the first device.

20. The system of claim 19, wherein the action comprises one or more of the IP (Internet protocol) address of the second network device or the UDN (unique device name) of the second network device.

21. The system of claim 19, wherein the network topology service is to generate a response to the action.

22. The system of claim 19, wherein the network topology service comprises network topology data.

23. The system of claim 22, wherein the network topology data includes a network topology map.

24. The system of claim 22, wherein the network topology data includes a state variable to identify peers of the network device.

25. The system of claim 19, wherein the first device and the second device are to exchange network topology data.

26. A machine-readable medium having stored thereon data representing sequences of instructions that, when executed by a processor, cause the processor to perform operations comprising:
receiving a request from a control point for a first network device, the request inquiring whether a network path exists with a second network device;
determining whether a network path with the second network device exists; and
sending a response to the control point, the response comprising an indication whether the network path exists.

27. The medium of claim 26, wherein determining whether the network path exists comprises sending an action to devices on a network, the action to request a response from a device receiving the action.

28. The medium of claim 27, wherein the request comprises an M-SEARCH action.

29. The medium of claim 26, wherein determining whether the network path exists comprises monitoring a network to determine whether the second network device is connected to the network.

30. The medium of claim 29, wherein monitoring the network comprises listening for SSDP (simple service discovery protocol) advertisements from the second network device.
